(19) United States
(12) Patent Application Publication
(10) Pub. No.: US 2001/0055546 A1
(43) Pub. Date: Dec. 27, 2001

(54) Method and apparatus for controlling fluid flow rate in a microfluidic circuit

(76) Inventors: Bernhard H. Weigl, Seattle, WA (US); Thomas Schulte, Redmond, WA (US); Ronald L. Bardell, Redmond, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/888,727

(22) Filed: Jun. 25, 2001

Related U.S. Application Data
(60) Provisional application No. 60/213,865, filed on Jun. 23, 2000.

(51) Int. Cl. G01N 21/05; B01L 3/02

(52) U.S. Cl. 422/100; 356/246

(57) ABSTRACT

A method and apparatus are disclosed for controlling a flow rate of a fluid sample having an unknown or variable viscosity. The fluid sample is provided as a first fluid flow to a microfluidic channel. A second fluid is provided to the channel as a sheath around the first fluid. In one embodiment, the second fluid is injected between the first fluid flow and an internal surface of the channel. In another embodiment, the second fluid completely circumscribes the first fluid as a parallel or sheath flow. The second fluid has a known viscosity selected for achieving a flow rate. The first fluid flows at the same rate as the achieved flow rate of the second fluid.

This application claims the benefit of U.S. Provisional Application No. 60/213,865, filed Jun. 23, 2000 and entitled “MICROFLUIDIC SYSTEMS AND METHODS,” which is incorporated herein in its entirety. This application also relates to U.S. Patent Application No. 09/428,807, filed Oct. 28, 1999 and entitled “SHEATH FLOW ASSEMBLY,” which is incorporated by reference herein for all purposes.

### BACKGROUND OF THE INVENTION

This invention generally relates to microfluidics, and more particularly to controlling a flow of a fluid in a microfluidic circuit. Microfluidics relates to systems that exploit physical properties and flow characteristics of fluids within micro-sized channels of capillary dimensions.

In volume-controlled microfluidic circuits, fluids having different viscosities that flow next to each other take up different amounts of space within a channel, either by having a different cross-sectional area or different relative volumes within the channel. Similarly, in pressure-controlled microfluidic circuits, including, for example, gravity-fed circuits, fluids having different viscosities and flowing next to each other take up the same amount of space, but flow at different volume flow rates. For fluids which have an unknown or varying viscosity, this phenomenon presents a problem for cases in which a constant or accurate flow rate is required, or in which the position of the interface between two fluids next to each other must be known.

Furthermore, fluids having non-dissolved particles dispersed within them show a flow behavior that is different from that of a particle-free fluid, even if the viscosities of the fluids are similar. Depending on a variety of forces that may occur between the particles, between the particles and the fluid, and other forces applied to the particles by the hydrodynamic shear stress and flow profile within a microchannel, such particle-laden fluids may also take up different amounts of space in volume-controlled circuits, or have different flow rates in pressure-controlled circuits. In addition, the particles themselves may be uncontrollably forced to different areas of the channel by any of these forces, whereas the fluids in which they are contained would remain in place.

### BRIEF DESCRIPTION OF THE DRAWING

FIG. 1 is a graph illustrating a parabolic flow rate distribution in a microchannel having two side walls each defining an internal surface.

FIG. 2 depicts one embodiment of an injection structure suitable for the invention.

FIGS. 3-5 illustrate various alternative cross-sections of inlets to a microfluidic channel.

### DETAILED DESCRIPTION OF THE PREFERRED EMBODIMENTS

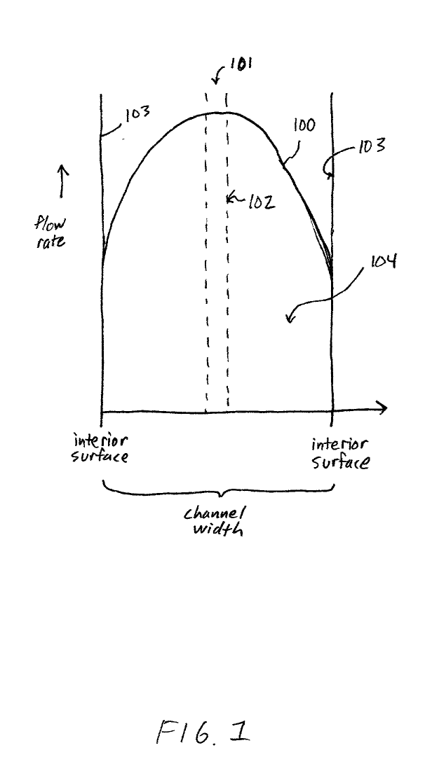

Flow rate is a function of cross-sectional area of a fluid within a channel, and the rate of speed with which the fluid travels through the channel. Several other factors affecting a fluid's flow rate include the fluid's viscosity, or property of resistance to flow, the composition and configuration of the channel, and the presence of other adjacently flowing fluids. In general, the effect of a fluid's viscosity on flow rate is more pronounced closer to internal surfaces of the channel, usually defined by the channel walls. FIG. 1 illustrates this property, in which a flow speed of a fluid with a known viscosity has a parabolic distribution 100 within a microchannel, the flow being slower at and near the walls 103 of the channel and faster toward the center of the channel.

With reference to FIG. 1, it is shown that a center region 101 of the parabolic distribution 100 is substantially flat, representing a constant or near-constant flow rate across the region. In accordance with the invention, a fluid sample 102 that requires a constant or accurate flow rate is sheathed in a second fluid 104. The fluid sample 102, or first fluid, is injected as a flow into the channel, preferably within a small, center portion of the entire stream in the area 101 in which flow rate is constant. The first fluid can have an unknown or variable viscosity that would otherwise inhibit a constant or accurate flow rate. The second fluid 104 sheaths the first fluid 102 and has a known viscosity, such that the second fluid has a constant or accurately known flow rate at the interface with the first fluid 102. Accordingly, the first fluid 102 will maintain substantially the same constant or accurate flow rate as the second fluid at the interface.

The first fluid 102, if containing non-dissolved particles, is also protected against forces which can affect the flow rate and direction of the first fluid, or any non-dissolved particles dispersed therein. These forces are substantially perpendicular to the direction of the flow of the first fluid 102. Being susceptible to these forces, the non-dissolved particles can be moved, altering the flow of the first fluid 102. These forces include, but not limited to, hydrodynamic shear stress, hydrodynamic shear lift, and elastic collision of particles.

Many different microfluidic structures and injection mechanisms can be employed to sheath a fluid sample with a fluid of known viscosity for achieving a constant and/or accurate flow rate for the fluid sample. U.S. Pat. Nos. 5,932,100 to Yager et al., 5,948,684 to Weigl et al., and 6,159,739 to Weigl et al., the contents of which are incorporated by reference herein in their entirety, describe various structures, mechanisms and methods for sheathing a fluid within another fluid.

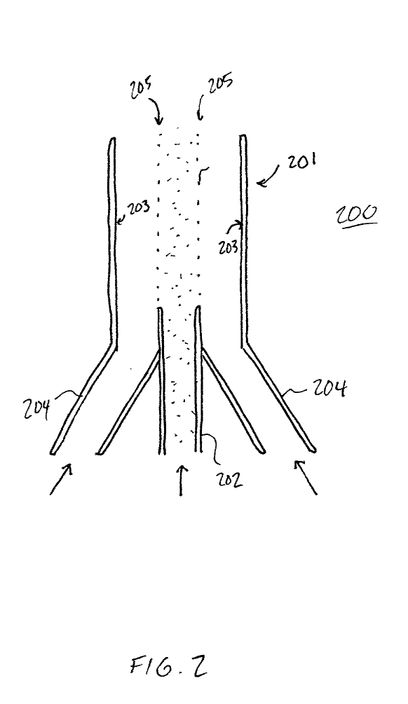

FIG. 2 is a two-dimensional cross-sectional view of an injection structure 200 consistent with a device known as a “T”-Sensor, which includes a microfluidic channel 201 having side walls 203 that define an internal surface. The microfluidic channel 201 has a primary inlet 202 for receiving a first fluid flow, and secondary inlets 204 for receiving one or more second fluid flows. Those having the requisite skill in the art will recognize that secondary inlets 204 are depicted as separate, but could form different parts of one inlet in a three-dimensional configuration.

The second fluid sheaths the first fluid, to isolate the first fluid from the side walls 203 of the channel 201. The first fluid has an unknown or variable viscosity, which has minimal effect on the flow rate of the first fluid since the first fluid will flow at substantially the same rate as the second fluid where the two fluids interface, at 205. The second fluid has a known viscosity selected for achieving a particular flow rate at the interface 205.

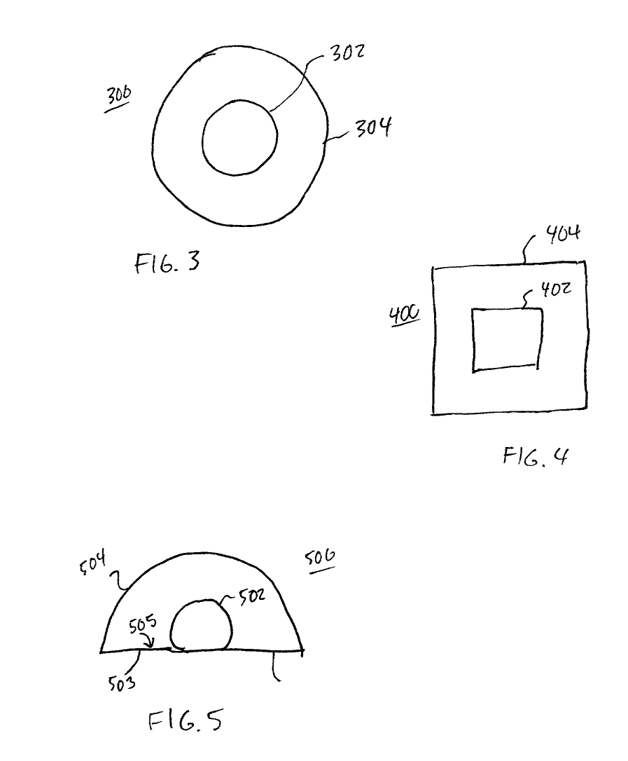

The structure 200 shown in FIG. 2 is shown as two-dimensional for example only, and not limitation. In a third-dimensional, many different cross-sectional profiles can be used. FIGS. 3-5 show several embodiments of inlets or injectors to a microfluidic channel. Many other embodiments are possible within the scope of the invention. FIG. 3 is a cross-section of a circular arrangement 300 of inlets. The arrangement includes a first inlet 302 for providing a first fluid, and a second inlet 304 for providing a second fluid that sheaths the first fluid. In the arrangement shown, the second inlet 304 circumscribes the first inlet 302, at least in close proximity to the channel.

FIG. 4 shows a similar arrangement 400 in which the first inlet 402 and the second inlet 404 are rectangular. It should be understood that, in any embodiment, the second inlet need not necessarily conform to the exact shape of the first inlet. Thus, with reference to FIG. 4, the second inlet 404 could be a different shape, i.e. rounded, than the first inlet 402. The second fluid is preferably provided by the second inlet 404 to sheath, or surround, the first fluid, or at least isolate the first fluid from contact with an internal surface of the channel.

FIG. 5 shows an alternative embodiment of an arrangement 500 in which a second inlet 504 only partially surrounds the first inlet 502. In such an arrangement, effects of the viscosity of the first fluid can be mitigated at the channel wall 503 not completely interceded with the second fluid, by a a coating 505 on the wall 503.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of controlling a flow of a fluid sample, comprising:
providing a first fluid as a flow in a microfluidic channel; and
sheathing the first fluid with a second fluid having a known viscosity, such that the first fluid has a flow rate that is substantially equal to a flow rate of the second fluid at the interface with the first fluid.

2. The method of claim 1, further comprising contacting the first fluid with the second fluid.

3. The method of claim 1, wherein the first fluid and the second fluid flow in contact with each other.

4. The method of claim 1, wherein sheathing the first fluid includes injecting the second fluid into the channel at least partially around the first fluid.

5. The method of claim 4, wherein the second fluid is injected on either side of the first fluid in a two-dimensional sheath flow.

6. The method of claim 4, wherein the second fluid completely surrounds the first fluid in a three-dimensional sheath flow.

7. The method of claim 6, wherein the three-dimensional sheath flow has a rounded cross-sectional profile.

8. The method of claim 6, wherein the three-dimensional sheath flow has a squared cross-sectional profile.

9. The method of claim 1, wherein the second fluid is configured to minimize contact of the first fluid with an internal surface of the microfluidic channel.

10. The method of claim 10, wherein the second fluid is configured to insulate the first fluid from contact with an internal surface of the microfluidic channel.

11. A method of controlling a flow of a fluid sample, comprising:
providing a first fluid as a flow in a microfluidic channel, the first fluid having an unknown or variable viscosity; and
sheathing the first fluid with a second fluid having a known viscosity, such that the first fluid has a flow rate that is substantially equal to a flow rate of the second fluid at the interface with the first fluid.

12. The method of claim 11, wherein the known viscosity of the second fluid is adapted for maintaining a particular flow rate for the first fluid in the microfluidic channel.

13. An apparatus for controlling a flow of a fluid samples in a microfluidic channel, comprising:
a first fluid, provided as a flow in the microfluidic channel;
a second fluid, provided as a flow between an internal surface of the channel and the first fluid, the second fluid having a known viscosity tailored to achieve a constant flow rate at a the interface with the first fluid, such that the first fluid achieves substantially the constant flow rate independent of a viscosity associated with the first fluid.

14. The apparatus of claim 13, wherein the second fluid sheaths the first fluid.

15. A method of controlling a flow of a fluid sample, comprising:
providing a first fluid as a flow in a microfluidic channel; and
providing a second fluid as a flow in the microfluidic channel between the first fluid and an internal surface of the channel, the second fluid having a known viscosity, such that the first fluid has a flow rate that is substantially equal to a flow rate of the second fluid at the interface with the first fluid.

16. The method of claim 15, wherein the second fluid sheaths the first fluid.

17. A system for performing a microfluidic process, comprising:
a microfluidic channel, having a first inlet for receiving a first fluid flow and a second inlet for receiving a second fluid flow in between the first fluid flow and an internal surface of the channel, the second fluid having a viscosity that is selected for achieving a particular, constant flow rate at the interface with the first fluid, such that the first fluid flow achieves a flow rate that is substantially equal to the flow rate of the second fluid at the interface with the first fluid.

18. The system of claim 17, wherein the second inlet surrounds the first inlet.

19. The system of claim 17, wherein the first and/or the second inlets are squared.

20. The system of claim 17, wherein the first and/or second inlets are rounded.

21. The system of claim 17, wherein the first fluid has an unknown or variable viscosity.

22. A method of controlling a flow of a fluid sample, comprising:
injecting a first fluid into a microfluidic channel; and
injecting a second fluid into the channel adjacent to the first fluid, the second fluid having a known viscosity, such that the first fluid has a flow rate that is substantially equal to a flow rate of the second fluid at the interface between the first and second fluid.

23. The method of claim 22, wherein injecting the second fluid further includes forming a sheath around the first fluid with the second fluid.

24. The method of claim 23, wherein the second fluid insulates the first fluid from contact with an internal surface of the microfluidic channel.

25. A method of controlling a flow of a fluid sample, comprising:
providing a first fluid as a flow in a microfluidic channel, the first fluid containing non-dissolved particles that are susceptible to forces which affect the flow of the first fluid; and
sheathing the first fluid within a second fluid having a controlled flow, so as to substantially insulate the first fluid from the forces.

26. The method of claim 25, wherein the forces include hydrodynamic shear stress within the microfluidic channel.

27. The method of claim 25, wherein the second fluid has a known viscosity selected for achieving a particular flow profile within the microfluidic channel.

28. A method of controlling a flow of a fluid sample, comprising:
providing a first fluid as a flow in a microfluidic channel, the first fluid containing non-dissolved particles that are susceptible to forces which affect the flow of said non-dissolved particles within said microfluidic channel; and
sheathing the first fluid within a second fluid having a controlled flow, so as to substantially insulate said first fluid from the forces.

29. A method of controlling a flow of a fluid sample, comprising:
providing a first fluid as a flow in a microfluidic channel, the first fluid containing non-dissolved particles that are susceptible to forces which are substantially perpendicular to the direction of flow within said microfluidic channel; and
sheathing the first fluid within a second fluid having a controlled flow, so as to substantially insulate said first fluid from the forces.

30. The method of claim 29, wherein the forces include hydrodynamic shear stress within the microfluidic channel.

31. The method of claim 29, wherein the forces include hydrodynamic shear lift within the microfluidic channel.

32. The method of claim 29, wherein the forces include elastic collisions of particles within the microfluidic channel.
